(19) United States
(12) Patent Application Publication
(10) Pub. No.: US 2007/0291247 A1
(43) Pub. Date: Dec. 20, 2007

(54) Apparatus for exposing an edge portion of a wafer

(75) Inventors: Kyoung-Ho Kim, Suwon-si (KR); Jae-Hyun Sung, Hwaseong-si (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (JP)

(21) Appl. No.: 11/804,469

(22) Filed: May 18, 2007

(30) Foreign Application Priority Data
Jun. 14, 2006 (KR) 10-2006-0053273

(51) Int. Cl. G03B 27/72

(52) U.S. Cl. 355/69; 355/67

(57) ABSTRACT

In an apparatus for performing an edge exposure process on an edge portion of a photoresist film that is formed on a semiconductor wafer, light provided from a light source is formed to have a ring shape corresponding to a shape of an edge portion of the wafer by an optical unit. The ring-shaped light is irradiated onto the edge portion of the wafer through a ring lens. Thus, the light efficiency is improved. Further, since there is no need to rotate the wafer, a side surface profile of the photoresist film is improved.

### CROSS-REFERENCE TO RELATED APPLICATIONS

This application claims priority under 35 USC § 119 to Korean Patent Application No. 10-2006-0053273 filed on Jun. 14, 2006, the contents of which are incorporated herein by reference in their entirety.

### BACKGROUND OF THE INVENTION

1. Field of the Invention

Embodiments of the present invention relate to an apparatus for exposing an edge portion of a wafer. More particularly, embodiments of the present invention relate to an apparatus for exposing an edge portion of a wafer to remove the edge portion of the photoresist film.

2. Description of the Related Art

Semiconductor devices, in general, are manufactured by repeatedly performing a number of processes on a silicon wafer that may be used as a semiconductor substrate. For example, a deposition process may be performed to form a layer on a semiconductor wafer, and a photolithography process may be performed to form photoresist patterns on the layer. An etching process may be performed to form a surface portion of the semiconductor wafer or the applied layer into desired patterns, and a planarization process may be performed to planarize a surface portion of the applied layer. Further, a cleaning process may be performed to remove impurities from the surface of the semiconductor wafer, and an inspection process may be performed to detect defects of the applied layer or patterns on the semiconductor wafer.

The photolithography process may include a coating process for coating the semiconductor wafer with a photoresist composition so as to form the photoresist film on the semiconductor wafer, an exposure process and a developing process for forming the photoresist film into the photoresist patterns, a baking process for hardening the photoresist film or the photoresist patterns formed on the wafer, and an edge exposure process and an edge developing process for removing an edge portion of the photoresist film from the wafer.

FIG. 1 is a schematic view illustrating a conventional apparatus for exposing an edge portion of a wafer.

Referring to FIG. 1, a conventional apparatus 100 for exposing an edge portion of a semiconductor wafer 10 includes a chuck 110 for supporting the semiconductor wafer 10, a driving section 120 for rotating the chuck 110, a light source 130 for providing light, and a condenser lens 140 for directing the light onto an edge portion of the wafer 10.

The chuck 110 may hold the semiconductor wafer 10 using a vacuum force or an electrostatic force. The driving section 120 is connected to the chuck 110 by a rotary shaft 122 and rotates the chuck 110 to expose the edge portion of the wafer 10 to the light.

The light source 130 includes a lamp 132 for generating the light and a hemispherical mirror 134 surrounding the lamp 132 to reflect the light toward the condenser lens 140. A slit nozzle 150 is disposed between the condenser lens 140 and the wafer 10, and the light passing through the condenser lens 140 is irradiated onto the edge portion of the wafer 10 through the slit nozzle 150.

In the conventional apparatus, light efficiency is poor, because only a portion of the light generated by the lamp 132 is irradiated onto the edge portion of the wafer 10 through the condenser lens 140 and the slit nozzle 150. Accordingly, the exposure light may not be sufficiently provided onto the edge portion of the wafer 10.

Further, the rotation of the wafer 10 may generate some level of noise, thereby deteriorating the uniformity of the exposure light irradiated onto the edge portion of the wafer 10.

Consequently, after performing the edge exposure process and the edge developing process, a surface profile of an edge portion of the photoresist film may be deteriorated. For example, an edge line of the photoresist film may be non-uniformly formed. Further, as shown in FIG. 2, the applied photoresist film can have an inclined side surface, and a width of the inclined side surface can thereby be increased.

### SUMMARY OF THE INVENTION

Example embodiments of the present invention provide an apparatus for exposing an edge portion of a wafer that is capable of improving a light efficiency and a side surface profile of a photoresist film.

In one aspect, an apparatus that exposes an edge of a wafer, includes a light source that generates a light beam, an optical unit that forms the light beam into a ring-shaped light beam corresponding to a shape of an edge portion of a wafer, and a ring lens that directs the ring-shaped light beam onto the edge portion of the wafer.

In some example embodiments of the present invention, the apparatus may further include a chuck that supports the wafer.

In some example embodiments of the present invention, the optical unit may include an inner diffractive optical element disposed between the light source and the ring lens to direct the light beam onto the ring lens, and an outer diffractive optical element surrounding the inner diffractive optical element to direct the light beam onto the ring lens.

In some example embodiments of the present invention, the light source may include a lamp that generates the light beam, and a hemispherical mirror surrounding the lamp to reflect the light beam toward the optical unit.

In some example embodiments of the present invention, the inner diffractive optical element may have a cone shape and a diffraction grating surface for directing the light beam onto the ring lens.

In some example embodiments of the present invention, the inner diffractive optical element may have a hemispherical shape and a diffraction grating surface for directing the light onto the ring lens.

In some example embodiments of the present invention, the outer diffractive optical element may have a cylindrical shape and a diffraction grating surface for directing the light onto the ring lens.

In some example embodiments of the present invention, the outer diffractive optical element may have a funnel shape having a circumference that expands in a direction toward the ring lens, and a diffraction grating surface for directing the light beam onto the ring lens.

In some example embodiments of the present invention, the outer diffractive optical element may include a first portion having a funnel shape having a circumference that expands in a direction toward the ring lens and a first diffraction grating surface for directing the light beam onto the ring lens, and a second portion extending from the first portion toward the ring lens and having a substantially constant diameter and a second diffraction grating surface for directing the light beam onto the ring lens.

In some example embodiments of the present invention, the optical unit may include an inner diffractive optical element disposed between the light source and the ring lens to direct the light onto the ring lens, and an outer diffractive optical element surrounding the light source and the inner diffractive optical element to direct the light beam onto the ring lens.

In some example embodiments of the present invention, the apparatus may further include a shutter disposed between the wafer and the ring lens to selectively block the light beam passing through the ring lens.

In accordance with the example embodiments of the present invention, the light beam provided from the light source may be directed onto the edge portion of the wafer through the ring lens and the shutter. Thus, the light efficiency may be improved. Further, since there is no need to rotate the wafer, the side surface profile of the resulting photoresist film on the wafer may be improved, and the time required for the wafer edge exposure process may be shortened.

### BRIEF DESCRIPTION OF THE DRAWINGS

Example embodiments of the present invention will become readily apparent along with the following detailed description when considered in conjunction with the accompanying drawings wherein:

FIG. 1 is a schematic view illustrating a conventional apparatus for exposing an edge portion of a wafer;

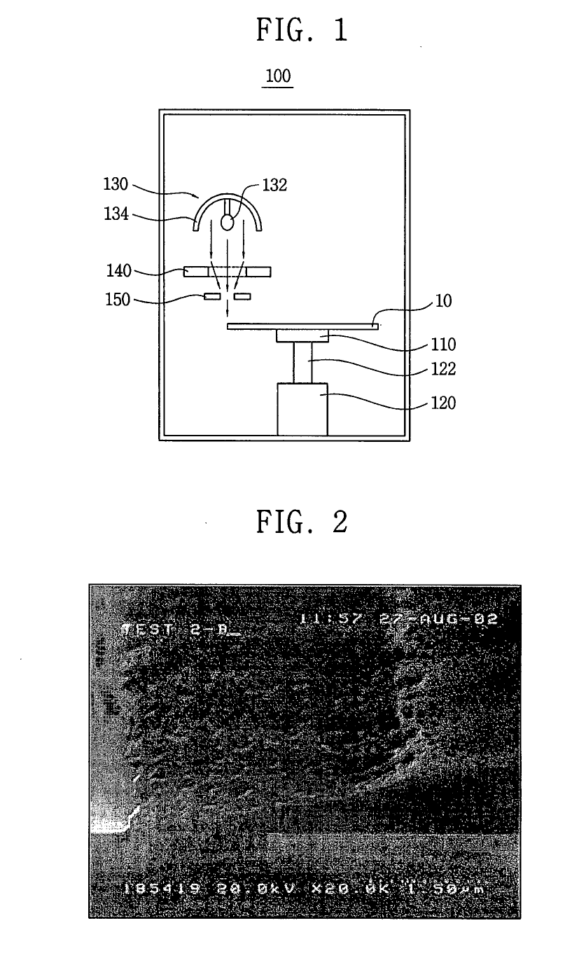

FIG. 2 is a scanning electron microscope (SEM) picture showing a side surface profile of a photoresist film treated by the conventional apparatus as shown in FIG. 1;

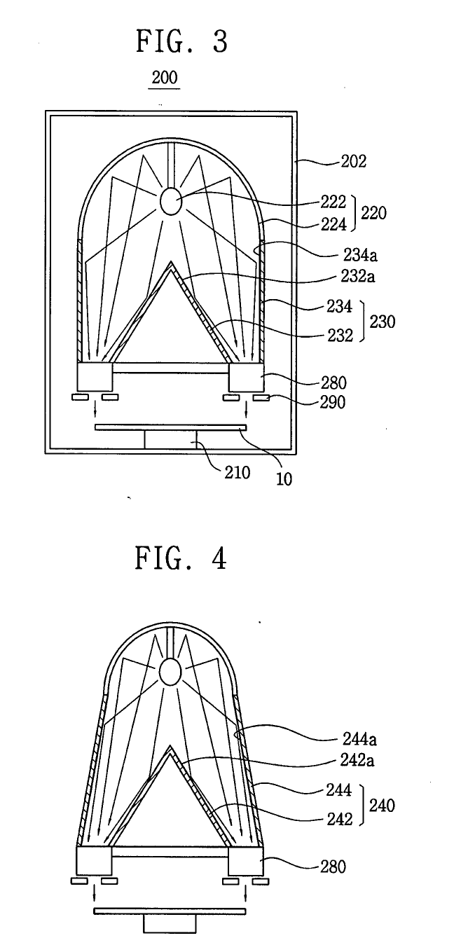

FIG. 3 is a schematic view illustrating an apparatus for exposing an edge portion of a wafer in accordance with an example embodiment of the present invention;

FIGS. 4 to 7 are schematic views illustrating various example embodiments of an optical unit as shown in FIG. 3;

FIG. 8 is a schematic view illustrating an apparatus for exposing an edge portion of a wafer in accordance with another example embodiment of the present invention; and

FIGS. 9 to 11 are schematic views illustrating various example embodiments of an optical unit as shown in FIG. 8.

### DETAILED DESCRIPTION OF THE EMBODIMENTS

Embodiments of the invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present. In contrast, when an element is referred to as being “directly on” another element, there are no intervening elements present. As used herein, the term “and/or” includes any and all combinations of one or more of the associated listed items.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompass both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Example embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present invention.

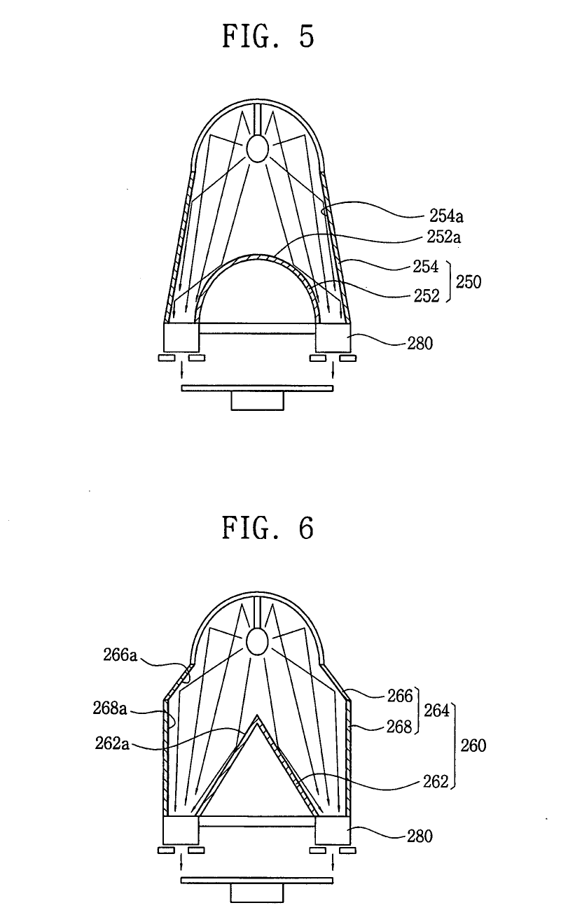

FIG. 3 is a schematic view illustrating an apparatus for exposing an edge portion of a wafer in accordance with an example embodiment of the present invention.

Referring to FIG. 3, an apparatus 200 for exposing an edge portion of a semiconductor wafer 10 may be used to perform an edge exposure process on a photoresist film formed on the semiconductor wafer 10 such as a silicon wafer.

The semiconductor wafer 10 on which the photoresist film is formed may be supported by a chuck 210 disposed in an exposure chamber 202. The chuck 210 may hold the semiconductor wafer 10 using a vacuum force or an electrostatic force.

A light source 220 for generating light may be disposed in an upper portion of the exposure chamber 202. An optical unit 230 may be disposed between the light source 220 and the chuck 210 to form the light beam into a ring-shaped light beam that corresponds to a shape of an edge portion of the semiconductor wafer 10. Further, a ring lens 280 may be disposed between the optical unit 230 and the chuck 210 to direct the ring-shaped light onto the edge portion of the wafer 10. A shutter 290 may be disposed between the ring lens 280 and the chuck 210 to selectively block the ring-shaped light passing through the ring lens 280.

The optical unit 230 may include an inner diffractive optical element 232 disposed between the light source 220 and the ring lens 280 to direct the light onto the ring lens 280 and an outer diffractive optical element 234 surrounding the inner diffractive optical element to direct the light onto the ring lens 280.

The light source 220 may include a lamp 222 for generating the light and a hemispherical mirror 224 surrounding the lamp 222 to reflect the light in a direction toward the optical unit 230. In one example, the lamp 222 comprises a mercury lamp. In accordance with another example embodiment, the light source 220 can include a laser for generating laser beam, a beam expander for expanding the laser beam, and an optical integrator for providing a uniform expanded laser beam.

In one embodiment, the inner diffractive optical element 232 may have a cone shape. Further, the inner diffractive optical element 232 may have a first diffraction grating surface 232a to direct the light onto the ring lens 280. Particularly, a diffraction pattern may be formed on an outer surface of the inner diffractive optical element 232 to direct the light onto the ring lens 280.

The outer diffractive optical element 234 may surround the inner diffractive optical element 232 between the light source 220 and the ring lens 280, and may have a cylindrical shape. Further, the outer diffractive optical element 234 may have a second diffraction grating surface 234a to direct the light onto the ring lens 280. Particularly, a diffraction pattern may be formed on an inner surface of the outer diffractive optical element 234 to direct the light onto the ring lens 280.

As shown in FIG. 3, the light generated by the light source 220 may be directed onto the ring lens 280 by the inner and outer diffractive optical elements 232 and 234, and the edge portion of the semiconductor wafer 10 may be exposed to the ring-shaped light passing through the ring lens 180 and the shutter 290. Thus, a loss of the light generated by the light source 220 may be reduced, and thus the light efficiency of the resulting exposure apparatus 200 may be further improved.

Further, according to embodiments of the present invention, since there is no need to rotate the semiconductor wafer 10, a side surface profile of the photoresist film may be improved after subsequently performing an edge developing process.

Though not shown in figures, when the semiconductor wafer 10 has a flat zone portion, each of the inner and outer diffractive optical elements 232 and 234 may have a flat portion corresponding to the flat zone portion. Further, each of the ring lens 280 and the shutter 290 may have a shape corresponding to the edge portion of the semiconductor wafer 10.

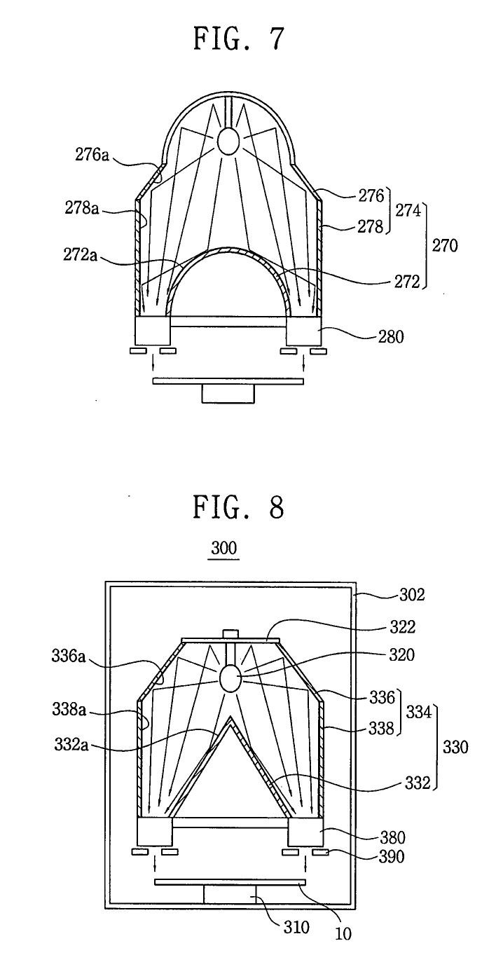

FIGS. 4 to 7 are schematic views illustrating various example embodiments of the optical unit as shown in FIG. 3.

Referring to FIG. 4, an optical unit 240 may include an inner diffractive optical element 242 and an outer diffractive optical element 244. The inner diffractive optical element 242 may have a cone shape and a first diffraction grating surface 242a for directing the light onto the ring lens 280. The outer diffractive optical element 244 may have a tapered funnel shape that expands in circumference in a direction toward the ring lens 280. Further, the outer diffractive optical element 244 may have a second diffraction grating surface 244a for directing the light onto the ring lens 280. Here, an inner surface of the outer diffractive optical element 244 may have an inclination angle that is greater than that of an outer surface of the inner diffractive optical element 242 with respect to an upper surface of the wafer 10.

Referring to FIG. 5, an optical unit 250 may include an inner diffractive optical element 252 and an outer diffractive optical element 254. The inner diffractive optical element 252 may have a hemispherical or semispherical shape and a first diffraction grating surface 252a for directing the light onto ring lens 280. The outer diffractive optical element 254 may have a funnel shape that expands in circumference in a direction toward the ring lens 280. Further, the outer diffractive optical element 254 may have a second diffraction grating surface 254a for directing the light onto the ring lens 280.

Referring to FIG. 6, an optical unit 260 may include an inner diffractive optical element 262 and an outer diffractive optical element 264. The inner diffractive optical element 262 may have a cone shape and a first diffraction grating surface 262a for directing the light onto the ring lens 280. The outer diffractive optical element 264 may include a first portion 266 having a funnel shape that expands in circumference in a direction toward the ring lens 280 and a second portion 268 having a cylindrical shape and extending from the first portion 266 toward the ring lens 280. In one embodiment, the second portion 268 may have a substantially constant diameter. The first and second portions 266 and 268 may have a second diffraction grating surface 266a and a third diffraction grating surface 268a for directing the light onto the ring lens 280, respectively.

Referring to FIG. 7, an optical unit 270 may include an inner diffractive optical element 272 and an outer diffractive optical element 274. The inner diffractive optical element 272 may have a hemispherical or semispherical shape and a first diffraction grating surface 272a for directing the light onto the ring lens 280. The outer diffractive optical element 274 may include a first portion 276 having a funnel shape that expands in circumference in a direction toward the ring lens 280 and a second portion 278 having a cylindrical shape and extending from the first portion 276 toward the ring lens 280. The second portion 278 may have a substantially constant diameter. The first and second portions 276 and 278 may have a second diffraction grating surface 276a and a third diffraction grating surface 278a for directing the light onto the ring lens 280, respectively.

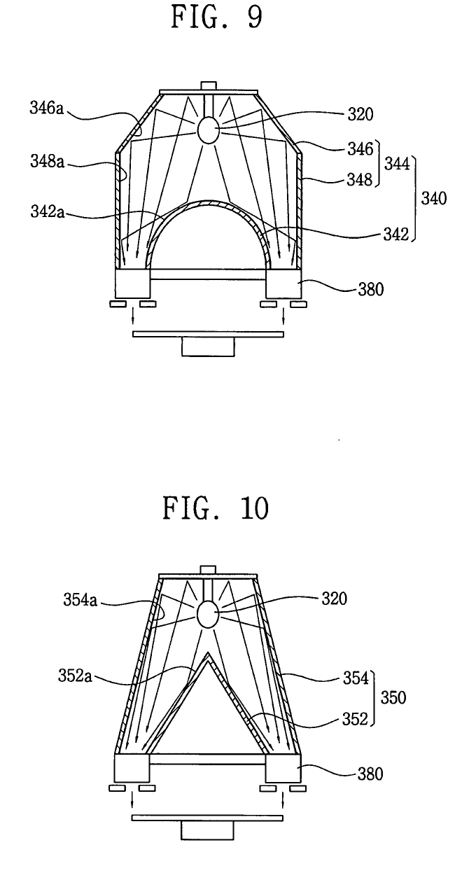

FIG. 8 is a schematic view illustrating an apparatus for exposing an edge portion of a wafer in accordance with another example embodiment of the present invention.

Referring to FIG. 8, an apparatus 300 for exposing an edge portion of a semiconductor wafer 10 may include an exposure chamber 302, a chuck 310, a light source 320, an optical unit 330, a ring lens 380 and a shutter 390. The above-mentioned elements other than the light source 320 and the optical unit 330 are similar to those already described in connection with the apparatus 200 as shown in FIG. 3 so any further detailed descriptions in these regards will be omitted.

Example of the light source 320 may include a mercury lamp, and a flat type mirror 322 may be disposed over the light source 320 to reflect the light generated from the light source 320 in a downward direction.

The optical unit 330 may include an inner diffractive optical element 332 disposed between the light 320 and the ring lens 380, and an outer diffractive optical element 334 surrounding the light source 320 and the inner diffractive optical element 332.

The inner diffractive optical element 332 may have a cone shape, and a first diffraction grating surface 332a for directing the light onto the ring lens 380. Particularly, a diffraction pattern may be formed on an outer surface of the inner diffractive optical element 332 to direct the light onto the ring lens 380. The outer diffractive optical element 334 may include a first portion 336 having a funnel shape that expands in circumference in a direction toward the ring lens 380 and a second portion 338 having a cylindrical shape and extending from the first portion 336 toward the ring lens 380. The second portion 338 may have a substantially constant diameter. Further, the first and second portions 336 and 338 of the outer diffractive optical element 334 may have a second diffraction grating surface 336a and a third diffraction grating surface 338a for directing the light onto the ring lens 380, respectively. Particularly, diffraction patterns may be formed on inner surfaces of the first and second portions 336 and 338 of the outer diffractive optical element 334 to direct the light onto the ring lens 380.

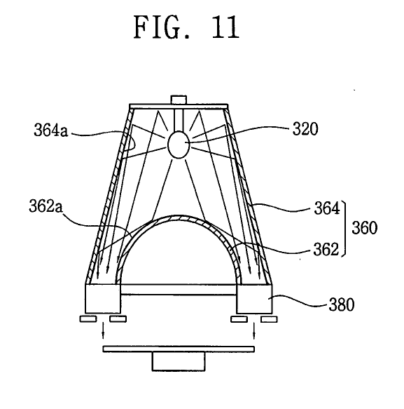

FIGS. 9 to 11 are schematic views illustrating various example embodiments of the optical unit as shown in FIG. 8.

Referring to FIG. 9, an optical unit 340 may include an inner diffractive optical element 342 and an outer diffractive optical element 344. The inner diffractive optical element 342 may be disposed between the light source 320 and the ring lens 380. The outer diffractive optical element 344 may surround the light source 320 and the Inner diffractive optical element 342.

The inner diffractive optical element 342 may have a hemispherical or semispherical shape and a first diffraction grating surface 342a for directing the light onto the ring lens 380. The outer diffractive optical element 344 may include a first portion 346 having a funnel shape that expands in circumference in a direction toward the ring lens 380 and a second portion 348 having a cylindrical shape and extending from the first portion 346 toward the ring lens 380. The second portion 348 may have a substantially constant diameter. Further, the first and second portions 346 and 348 of the outer diffractive optical element 344 may have a second diffraction grating surface 346a and a third diffraction grating surface 348a for directing the light onto the ring lens 380, respectively.

Referring to FIG. 10, an optical unit 350 may include an inner diffractive optical element 352 and an outer diffractive optical element 354. The inner diffractive optical element 352 may be disposed between the light source 320 and the ring lens 380. The outer diffractive optical element 354 may surround the light source 320 and the inner diffractive optical element 352.

The inner diffractive optical element 352 may have a cone shape and a first diffraction grating surface 352a for directing the light onto the ring lens 380. The outer diffractive optical element 354 may have a funnel shape that expands in circumference in a direction toward the ring lens 380 and a second diffraction grating surface 354a for directing the light onto the ring lens 380. Here, an inner surface of the outer diffractive optical element 354 may have an inclination angle greater than that of an outer surface of the inner diffractive optical element 352 with respect to the upper surface of the wafer 10.

Referring to FIG. 11, an optical unit 360 may include an inner diffractive optical element 362 and an outer diffractive optical element 364. The inner diffractive optical element 362 may be disposed between the light source 320 and the ring lens 380. The outer diffractive optical element 364 may surround the light source 320 and the inner diffractive optical element 362.

The inner diffractive optical element 362 may have a hemispherical or semispherical shape and a first diffraction grating surface 362a for directing the light onto the ring lens 380. The outer diffractive optical element 364 may have a funnel shape that expands in circumference in a direction toward the ring lens, 380 and a second diffraction grating surface 364a for directing the light onto the ring lens 380.

In accordance with the example embodiments of the present invention, light provided from a light source may be concentrated and formed to have a ring shape by an optical unit, and the ring-shaped light may be irradiated onto an edge portion of a semiconductor wafer through a ring lens and a shutter. As a result, the light efficiency may be improved. Further, since there is no need to rotate the wafer, because of the resulting ring-shaped exposure beam of light, a side surface profile of a photoresist film that is formed on the semiconductor wafer may be improved, and further the time required for the edge exposure process may be shortened.

Although example embodiments of the present invention have been described, it is understood that the present invention should not be limited to these example embodiments, but rather various changes and modifications can be made by those skilled in the art within the spirit and scope of the present invention as hereinafter claimed.

What is claimed is:

1. An apparatus that exposes an edge portion of a wafer comprising:
a light source that generates a light beam;
an optical unit that forms the light beam into a ring-shaped light beam corresponding to a shape of an edge portion of a wafer; and
a ring lens that directs the ring-shaped light beam onto the edge portion of the wafer.

2. The apparatus of claim 1, further comprising a chuck that supports the wafer.

3. The apparatus of claim 1, wherein the optical unit comprises:
an inner diffractive optical element disposed between the light source and the ring lens to direct the light beam onto the ring lens; and
an outer diffractive optical element surrounding the inner diffractive optical element to direct the light beam onto the ring lens.

4. The apparatus of claim 3, wherein the light source comprises:
a lamp that generates the light beam; and
a hemispherical mirror surrounding the lamp to reflect the light beam toward the optical unit.

5. The apparatus of claim 3, wherein the inner diffractive optical element has a cone shape and a diffraction grating surface for directing the light beam onto the ring lens.

6. The apparatus of claim 5, wherein the outer diffractive optical element has a funnel shape having a circumference that expands in a direction toward the ring lens and a diffraction grating surface for directing the light beam onto the ring lens.

7. The apparatus of claim 6, wherein an inclination angle of an inner surface of the outer diffractive optical element with respect to an upper surface of the wafer is greater than that of an outer surface of the inner diffractive optical element.

8. The apparatus of claim 3, wherein the inner diffractive optical element has a hemispherical shape and a diffraction grating surface for directing the light beam onto the ring lens.

9. The apparatus of claim 3, wherein the outer diffractive optical element has a cylindrical shape and a diffraction grating surface for directing the light beam onto the ring lens.

10. The apparatus of claim 3, wherein the outer diffractive optical element has a funnel shape having a circumference that expands in a direction toward the ring lens, and a diffraction grating surface for directing the light beam onto the ring lens.

11. The apparatus of claim 3, wherein the outer diffractive optical element comprises:
a first portion having a funnel shape having a circumference that expands in a direction toward the ring lens, and a first diffraction grating surface for directing the light beam onto the ring lens; and
a second portion extending from the first portion toward the ring lens and having a substantially constant diameter and a second diffraction grating surface for directing the light beam onto the ring lens.

12. The apparatus of claim 1, wherein the optical unit comprises:
an inner diffractive optical element disposed between the light source and the ring lens to direct the light beam onto the ring lens; and
an outer diffractive optical element surrounding the light source and the inner diffractive optical element to direct the light beam onto the ring lens.

13. The apparatus of claim 12, wherein the inner diffractive optical element has a cone shape and a diffraction grating surface for directing the light beam onto the ring lens.

14. The apparatus of claim 13, wherein the outer diffractive optical element has a funnel shape having a circumference that expands in a direction toward the ring lens and a diffraction grating surface for directing the light beam onto the ring lens, and an inclination angle of an inner surface of the outer diffractive optical element with respect to an upper surface of the wafer is greater than that of an outer surface of the inner diffractive optical element.

15. The apparatus of claim 12, wherein the inner diffractive optical element has a hemispherical shape and a diffraction grating surface for directing the light beam onto the ring lens.

16. The apparatus of claim 12, wherein the outer diffractive optical element has a funnel shape having a circumference that expands in a direction toward the ring lens, and a diffraction grating surface for directing the light beam onto the ring lens.

17. The apparatus of claim 12, wherein the outer diffractive optical element comprises:
a first portion having a funnel shape having a circumference that expands in a direction toward the ring lens, and a first diffraction grating surface for directing the light beam onto the ring lens; and
a second portion extending from the first portion toward the ring lens and having a substantially constant diameter and a second diffraction grating surface for directing the light beam onto the ring lens.

18. The apparatus of claim 1, further comprising a shutter disposed between the wafer and the ring lens to selectively block the light passing through the ring lens.
